(19) United States
(12) Patent Application Publication
(10) Pub. No.: US 2014/0071388 A1
(43) Pub. Date: Mar. 13, 2014

(54) LIQUID CRYSTAL DISPLAY DEVICE AND MANUFACTURING METHOD THEREOF

(71) Applicants: Ming Liu, Shenzhen (CN); Tao Ding, Shenzhen (CN)

(72) Inventors: Ming Liu, Shenzhen (CN); Tao Ding, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/510,364

(22) PCT Filed: Mar. 30, 2012
(86) PCT No.: PCT/CN2012/073355

§ 371 Date: Aug. 12, 2013

(30) Foreign Application Priority Data
Mar. 22, 2012 (CN) 2012100795051.9

(51) Int. Cl. G02F 1/1337

(52) U.S. Cl. CPC G02F 1/1337
USPC 349/123; 445/25

(57) ABSTRACT

The present invention discloses a liquid crystal display device and a manufacturing method thereof. The method includes: coating a polyimide (PI) solution on at least a portion area of an inner surface of a first substrate to form a first PI film; coating the PI solution on at least a portion area of an inner surface of a second substrate to form a second PI film; coating a seal on the second PI film; and mating the first substrate and the second substrate to each other to have the seal jointed to the first PI film. With this method, the present invention reduces moire patterns and halo effect so as to improve the result of displaying.

### BACKGROUND OF THE INVENTION

1. Field of the Invention

The present invention relates to the field of liquid crystal, and in particular to a liquid crystal display device and manufacturing method thereof.

2. The Related Arts

The function of an alignment film to have liquid crystal molecules align in a given direction to facilitate driving of a liquid crystal display device. Thus, in the manufacturing process of liquid crystal display device, a first substrate and a second substrate must be both subjected to alignment treatment for inner surfaces thereof.

The known technology carries out the alignment treatment with the following steps:

(1) A polyimide (PI) solution is coated on an area that is surrounded by a seal substance on a first substrate so as to form a first PI film and then, a rubbing fabric is applied to rub the first PI film so as to form grooves in a specific direction for alignment.

(2) The PI solution is coated on an area that is surrounded by a seal substance on a second substrate to form a second PI film and then, a rubbing fabric is applied to rub the second PI film so as to form grooves in a specific direction for alignment.

However, such a known method has the following problems:

(1) If a PI solution of high concentration is used, due to the high concentration, the diffusion of the PI solution is poor, making it easy to form moire pattern and thus affecting the result of displaying.

(2) If a PI solution of low concentration is used, since the PI solution has a low viscosity, accumulation of the PI solution along edges of a coated area may easily occur as being pressed during the process of coating a PI film and this makes the thickness of the PI film at the edges greater than that of a central area thereby causing a halo effect and affecting the result of displaying of the display area inside the seal frame.

### SUMMARY OF THE INVENTION

The primary technical issue to be addressed by the present invention is to provide a liquid crystal display device and a manufacturing method thereof in order to reduce the halo effect and improve the result of displaying.

To address the above discussed technical issue, the present invention adopts a technical solution by providing a method for manufacturing liquid crystal display device, which comprises: coating a polyimide (PI) solution completely on a whole inner surface of a first substrate to form a first PI film, wherein the PI solution has a concentration of solid content that is less than 7%; coating the PI solution on a second substrate in an area that is expanded to sites of cutting marks on the second substrate to form a second PI film; coating a seal on the second PI film; and mating the first substrate and the second substrate to each other to have the seal jointed to the first PI film.

Wherein, being bordered by a coating area of the seal, the second PI film comprises a first zone that is circumferentially enclosed by the coating area of the seal and a second zone that is located outside the coating area of the seal.

Wherein, the method further comprises the following step: coating conductive gold balls on the second PI film, the conductive gold balls being arranged in the coating area of the seal or the second zone, the conductive gold balls pressing through the first PI film and the second PI film to establish electrical connection between the first substrate and the second substrate.

Wherein, the conductive gold balls have an outside surface forming thorns for piercing through the first PI film and the second PI film to establish electrical connection between the first substrate and the second substrate.

To address the above discussed technical issue, the present invention adopts another technical solution by providing a method for manufacturing liquid crystal display device, which comprises: coating a polyimide (PI) solution on at least a portion area of an inner surface of a first substrate to form a first PI film; coating the PI solution on at least a portion area of an inner surface of a second substrate to form a second PI film; coating a seal on the second PI film; and mating the first substrate and the second substrate to each other to have the seal jointed to the first PI film.

Wherein, the first PI film is completely coated on the whole inner surface of the first substrate and the area where the second PI film is coated on the second substrate is expanded to sites of cutting marks on the second substrate.

Wherein, being bordered by a coating area of the seal, the second PI film comprises a first zone that is circumferentially enclosed by the coating area of the seal and a second zone that is located outside the coating area of the seal.

Wherein, the method further comprises the following step: coating conductive gold balls on the second PI film, the conductive gold balls being arranged in the coating area of the seal or the second zone, the conductive gold balls pressing through the first PI film and the second PI film to establish electrical connection between the first substrate and the second substrate.

Wherein, the conductive gold balls have an outside surface forming thorns for piercing through the first PI film and the second PI film to establish electrical connection between the first substrate and the second substrate.

Wherein, before the step of coating the PI to the inner surface of the second substrate, the method further comprises the flowing step: depositing a plurality of conductive plates on the inner surface of the second substrate to improve rate of conduction between the conductive gold balls and the second substrate.

Wherein, the PI solution has a concentration of solid content that is less than 7%.

Wherein, the concentration of solid content of the PI solution is set at 3%-7%.

Wherein, the alignment film has a thickness of 0.1 micrometer.

To address the above discussed technical issue, the present invention adopts a further technical solution by providing a liquid crystal display device, which comprises: a first substrate, which has an inner surface on which a first polyimide (PI) film is formed; a second substrate, which has an inner surface on which a second PI film is formed; a seal, which is arranged between the first PI film and the second PI film in such a way that areas where the first PI film and the second PI film are formed are expanded outside the seal; and a liquid crystal layer, which is arranged in a space delimited between the first substrate, the second substrate, and the seal.

Wherein, being bordered with the seal, the first PI film and the second PI film form a first zone that is circumferentially enclosed by the seal and a second zone that is located outboard the seal, the device further comprising conductive gold balls, which are arranged in the seal or the second zone to establish electrical connection between the first substrate and the second substrate.

Wherein, the conductive gold balls have an outside surface forming thorns.

Wherein, a plurality of conductive plates is arranged under the second PI film to improve the rate of conduction between the conductive gold balls and the first substrate.

Wherein, the alignment film has a thickness of 0.1 micrometer.

The efficacy of the present invention is that to be distinguished from the state of the art, the present invention expands the area where the PI solution is coated on the first substrate to outside the coating area of the seal of the liquid crystal display device and coating area of the second substrate is expanded outside the area enclosed by the seal so that the influence of halo effect on the result of displaying within the display zone inside the seal can be avoided.

Further, through using PI solutions of low concentration and excellent diffusion result to coat on the first substrate and the second substrate, the occurrence of moire pattern can be effectively prevented.

### BRIEF DESCRIPTION OF THE DRAWINGS

FIG. 1 is a front view showing a first embodiment of liquid crystal display device according to the present invention;

FIG. 2 is a side elevational view of FIG. 1;

FIG. 3 is a flow chart showing a first embodiment of manufacturing method of liquid crystal display device according to the present invention; and

FIG. 4 is a flow chart showing a second embodiment of manufacturing method of liquid crystal display device according to the present invention.

### DETAILED DESCRIPTION OF THE PREFERRED EMBODIMENTS

A detailed description will be given hereinafter with reference to the accompanying drawings and embodiments.

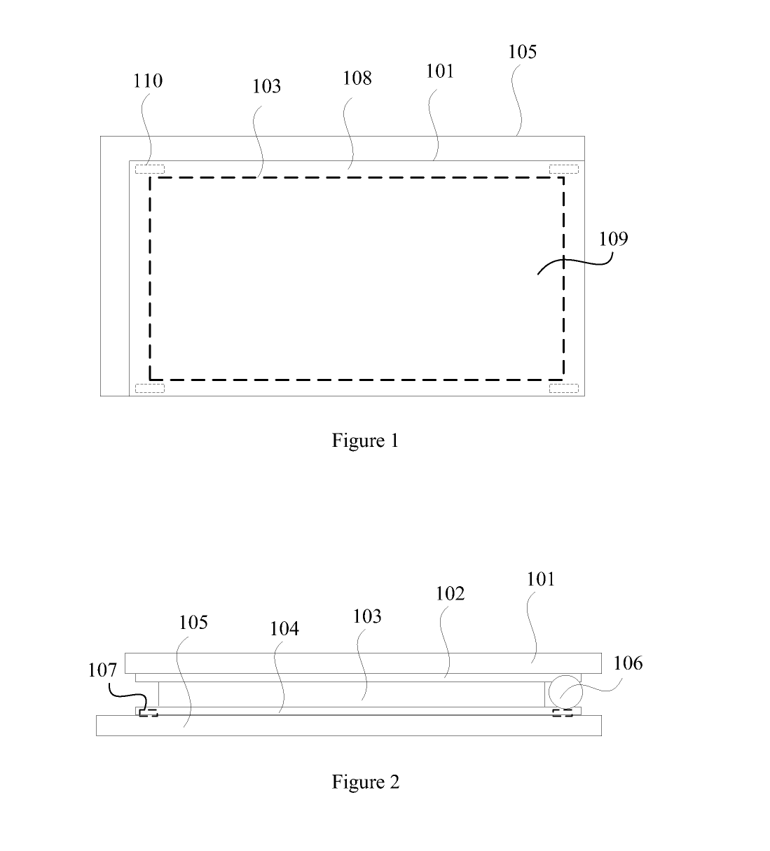

Referring to FIGS. 1 and 2, FIG. 1 is a front view showing a first embodiment of liquid crystal display device according to the present invention. FIG. 2 is a side elevational view of FIG. 1. In the instant embodiment, the liquid crystal display device comprises a first substrate 101, a seal 103, a second substrate 105, and a liquid crystal layer (not shown).

The first substrate 101 has an inner surface provided with a first polyimide (PI) film 102. The second substrate 105 has an inner surface provided with a second PI film 104. The first PI film 102 and the second PI film 104 are formed by drying PI solutions having a concentration of solid content less than 7%. After being dried, the first PI film 102 and the second PI film 104 have a thickness of 0.1 micrometer. In a preferred embodiment, the concentration of solid content of the PI solution is set at 3%-7%.

The seal 103 is arranged between the first PI film 102 and the second PI film 104 and areas where the first PI film 102 and the second PI film 104 are formed are expanded to outside the seal 103. In a preferred embodiment, the first PI film 102 is completely coated on the inner surface of the first substrate 101 and the coating area of the second PI film 104 on the second substrate 105 is expanded outside the second substrate 105 to the sites where cutting marks 110 are located. The cutting marks 110 indicate a contour of the first substrate 101.

Being bordered with the coating area of the seal 103, the second PI film 104 comprises a first zone 109 that is circumferentially enclosed by the coating area of the seal 103 and a second zone 108 that is located outboard the coating area of the seal 103. A conductive gold ball 106 is positioned in the second zone 108 and presses through the first PI film 102 and the second PI film 104, in order to have the first substrate 101 and the second substrate 105 in electrical connection with each other. In a preferred embodiment, the conductive gold ball 106 has an outside surface that forms thorns to pierce through the first PI film 102 and the second PI film 104 so as to establish electrical connection between the first substrate 101 and the second substrate 105.

Conductive plates 107 are positioned in the second zone 108 and the conductive plates 107 are located under the second PI film 104. The conductive gold ball 106 presses through or pierces through the second PI film 104 to establish electrical connection between the conductive gold ball 106 and the second substrate 105 so as to improve the rate of conduction.

In the instant embodiment, the first PI film 102 and the second PI film 104 are formed by drying PI solutions having a concentration of solid content less than 7% in order to effectively prevent the occurrence of moire pattern. Further, the areas where the first PI film 102 and the second PI film 104 are formed are expanded outboard the coating area of the seal 103 of the liquid crystal display device in order to prevent halo effect from affecting the result of displaying within the display zone inboard the seal 103.

Further, by arranging the conductive gold ball 106 and the conductive plate 107 within the second zone 108, the rate of electrical conduction between the first substrate 101 and the second substrate 105 can be effectively increased.

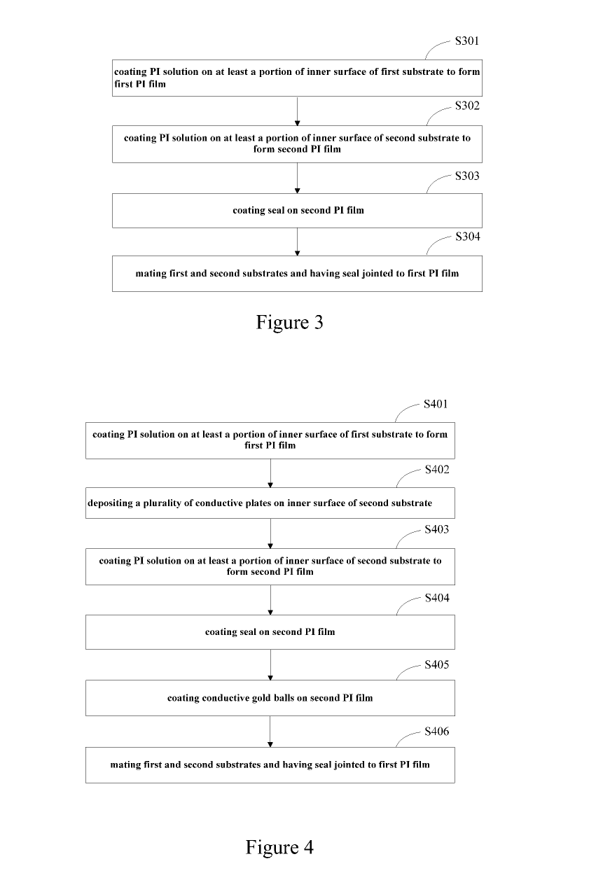

Referring to FIG. 3, FIG. 3 is a flow chart showing a first embodiment of manufacturing method of liquid crystal display device according to the present invention. As shown in FIG. 3, the method of the instant embodiment comprises the following steps:

Step S301: coating a PI solution on at least a portion area of an inner surface of a first substrate to form a first PI film.

A PI ink-jet coating machine is applied to coat the PI solution on a portion area of the inner surface of the first substrate. The PI ink-jet coating machine is controlled in such a way that the area where the first PI film is coated on the first substrate is expanded outside the area enclosed by a seal after mating. Further, the first PI film has a thickness of 0.1 micrometer. The inner surface of the first substrate is the surface on which a RGB filter is positioned. In a preferred embodiment, the PI solution is completely coated on the whole inner surface of the first substrate.

Step S302: coating the PI solution on at least a portion area of an inner surface of a second substrate to form a second PI film.

Again, a PI ink-jet coating machine is applied to coat the PI solution on a portion area of the inner surface of the second substrate. The PI ink-jet coating machine is controlled in such a way that the area where the second PI film is coated on the second substrate is expanded outside the coating area of a seal of the liquid crystal display device. Further, the second PI film has a thickness of 0.1 micrometer. The inner surface of the second substrate is the surface on which a film is deposited. In a preferred embodiment, the area where the second PI film is coated on the second substrate is expanded to the sites where cutting marks are located on the second substrate.

Step S303: coating a seal on the second PI film.

After coating the first PI film and the second PI film is completed, an alignment film rubbing machine is used to rub the first PI film and the second PI film with a rubbing fabric to form grooves in a specific orientation for alignment. Then, a seal dispenser is used to coat seal on the second PI film of the second substrate.

Step S304: mating the first substrate and the second substrate to each other to have the seal jointed to the first PI film.

After coating the seal is completed, the first substrate is mated with the second substrate to have the seal jointed to the first PI film. Before mating, being bordered with the coating area of the seal, the second PI film comprises a first zone that is circumferentially enclosed by the coating area of the seal and a second zone that is located outboard the coating area of the seal. After mating, being bordered with the seal, the first PI film and the second PI film form a first zone that is circumferentially enclosed by the seal and a second zone located outboard the seal. Then, the seal is cured and liquid crystal is injected inside the seal, and opening is closed to form the liquid crystal display device.

It is noted that in the instant embodiment, solid polyimide is dissolved in a solvent to form a solution, and the content of the solid polyimide is controlled so that the concentration of solid content of the PI solution is less than 7%. In a preferred embodiment, the concentration of solid content of the PI solution is set at 3%-7%.

In the instant embodiment, the area where the PI solution is coated on the first substrate is expanded outside the coating area of the seal of the liquid crystal display device and the coating area of the second substrate is expanded outside the area enclosed by the seal after mating so as to prevent the halo effect from affecting the result of displaying within the display zone inboard the seal.

Further, by using a PI solution of low concentration and good diffusion to coat on the first substrate and the second substrate, the occurrence of pattern can effectively prevented.

Referring to FIG. 4, FIG. 4 is a flow chart showing a second embodiment of manufacturing method of liquid crystal display device according to the present invention. As shown in FIG. 4, the method of the instant embodiment comprises the following steps:

Step S401: coating a PI solution on at least a portion area of an inner surface of a first substrate to form a first PI film.

Step S402: depositing a plurality of conductive plates on an inner surface of a second substrate.

In the manufacturing process of module, a conductive film is deposited on the second substrate by means of for example vapor deposition and liquid phase deposition and then, etching or corrosion is applied to form a plurality of conductive plates on the inner surface of the second substrate.

Step S403: coating a PI solution on a portion area of the inner surface of the second substrate to form a second PI film.

After the formation of the conductive plates, the second substrate that contains the conductive plates is conveyed to a PI ink-jet coating machine. The process that is used in Step S302 of the first embodiment illustrated in FIG. 3 is adopted to form the second PI film. Further, the conductive plates are covered under the second PI film.

Step S404: coating seal on the second PI film.

Step S405: coating conductive gold balls on the second PI film.

After coating the seal is completed, being bordered by coating area of the seal, the second PI film comprises a first zone that is circumferentially enclosed by the coating area of the seal and a second zone that is located outboard the coating area of the seal. The conductive gold balls are arranged within the coating area of the seal or the second zone.

Step S406: mating the first substrate and the second substrate to each other to have the seal jointed to the first PI film.

After coating the conductive gold ball is completed, mating facility is employed to mate the first substrate and the second substrate to each other and the seal jointed to the first PI film. The conductive gold balls are set to press through the first PI film and the second PI film to establish electrical connection between the first substrate and the second substrate. In a preferred embodiment, the conductive gold balls have an outside surface that forms thorns to facilitate piercing through the first PI film and the second PI film for establishing electrical connection between the first substrate and the second substrate. Specifically, the conductive gold balls press through or pierce through the second substrate to be in electrical connection with the conductive plates so as to improve the rate of conduction between the conductive gold balls and the second substrate. Further, the rate of conduction can also be improved by increasing the number of the conductive plates or increasing the pressure applied by the mating facility.

After mating, the seal is cured and liquid crystal is injection inside the seal and opening is closed to form the liquid crystal display device.

Step S401 is identical to Step S301 shown in FIG. 3 and Step 404 is identical to Step S303 of Figure, so that repeated description will be omitted.

In the instant embodiment, by arranging the conductive gold balls and the conductive plates in the second zone, the rate of electrical conduction between the first substrate and the second substrate can be improved.

In summary, the present invention expands the area where the PI solution is coated on the first substrate to outside the coating area of the seal of the liquid crystal display device and coating area of the second substrate is expanded outside the area enclosed by the seal so that the influence of halo effect on the result of displaying within the display zone inside the seal can be avoided.

Specifically, in case that the PI solution is completely coated on the whole inner surface of the first substrate, since the first PI film is only of a thickness of 0.1 micrometer, which can be considered virtually a transparent film and thus does not affect sensors detecting the cutting marks during the cutting process and not affecting the cutting operation. Thus, the halo area of the first substrate can be removed through cutting, while the halo area of the second substrate is located outside the seal and causes no influence on the display zone.

Further, using PI solutions of low concentration and excellent diffusion result to coat on the first substrate and the second substrate may effectively prevent the occurrence of moire pattern.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A method for manufacturing liquid crystal display device, comprising the following steps:
coating a polyimide (PI) solution completely on a whole inner surface of a first substrate to form a first PI film, wherein the PI solution has a concentration of solid content that is less than 7%;
coating the PI solution on a second substrate in an area that is expanded to sites of cutting marks on the second substrate to form a second PI film;
coating a seal on the second PI film; and
mating the first substrate and the second substrate to each other to have the seal jointed to the first PI film.

2. The method as claimed in claim 1, wherein being bordered by a coating area of the seal, the second PI film comprises a first zone that is circumferentially enclosed by the coating area of the seal and a second zone that is located outside the coating area of the seal.

3. The method as claimed in claim 2, wherein the method further comprises the following step:
coating conductive gold balls on the second PI film, the conductive gold balls being arranged in the coating area of the seal or the second zone, the conductive gold balls pressing through the first PI film and the second PI film to establish electrical connection between the first substrate and the second substrate.

4. The method as claimed in claim 3, wherein the conductive gold balls have an outside surface forming thorns for piercing through the first PI film and the second PI film to establish electrical connection between the first substrate and the second substrate.

5. A method for manufacturing liquid crystal display device, comprising the following steps:
coating a polyimide (PI) solution on at least a portion area of an inner surface of a first substrate to form a first PI film;
coating the PI solution on at least a portion area of an inner surface of a second substrate to form a second PI film;
coating a seal on the second PI film; and
mating the first substrate and the second substrate to each other to have the seal jointed to the first PI film.

6. The method as claimed in claim 5, wherein the first PI film is completely coated on the whole inner surface of the first substrate and the area where the second PI film is coated on the second substrate is expanded to sites of cutting marks on the second substrate.

7. The method as claimed in claim 5, wherein being bordered by a coating area of the seal, the second PI film comprises a first zone that is circumferentially enclosed by the coating area of the seal and a second zone that is located outside the coating area of the seal.

8. The method as claimed in claim 7, wherein the method further comprises the following step:
coating conductive gold balls on the second PI film, the conductive gold balls being arranged in the coating area of the seal or the second zone, the conductive gold balls pressing through the first PI film and the second PI film to establish electrical connection between the first substrate and the second substrate.

9. The method as claimed in claim 8, wherein the conductive gold balls have an outside surface forming thorns for piercing through the first PI film and the second PI film to establish electrical connection between the first substrate and the second substrate.

10. The method as claimed in claim 8, wherein before the step of coating the PI to the inner surface of the second substrate, the method further comprises the flowing step:
depositing a plurality of conductive plates on the inner surface of the second substrate to improve rate of conduction between the conductive gold balls and the second substrate.

11. The method as clamed in claim 5, wherein the PI solution has a concentration of solid content that is less than 7%.

12. The method as claimed in claim 11, wherein the concentration of solid content of the PI solution is set at 3%-7%.

13. The method as claimed in claim 5, wherein the alignment film has a thickness of 0.1 micrometer.

14. A liquid crystal display device, comprising:
a first substrate, which has an inner surface on which a first polyimide (PI) film is formed;
a second substrate, which has an inner surface on which a second PI film is formed;
a seal, which is arranged between the first PI film and the second PI film in such a way that areas where the first PI film and the second PI film are formed are expanded outside the seal; and
a liquid crystal layer, which is arranged in a space delimited between the first substrate, the second substrate, and the seal.

15. The device as claimed in claim 14, wherein being bordered with the seal, the first PI film and the second PI film form a first zone that is circumferentially enclosed by the seal and a second zone that is located outboard the seal, the device further comprising conductive gold balls, which are arranged in the seal or the second zone to establish electrical connection between the first substrate and the second substrate.

16. The device as claimed in claim 15, wherein the conductive gold balls have an outside surface forming thorns.

17. The device as claimed in claim 15, wherein a plurality of conductive plates is arranged under the second PI film to improve the rate of conduction between the conductive gold balls and the first substrate.

18. The device as claimed in claim 14, wherein the alignment film has a thickness of 0.1 micrometer.
